(19) United States
(12) Patent Application Publication
(10) Pub. No.: US 2019/0179809 A1
(43) Pub. Date: Jun. 13, 2019

(54) System and method for meaningful research investment metrology

(71) Applicants: Mathieu Marchand, Atlanta, GA (US); Spencer L. Shorte, St Piat (FR); Stratocore S.A.S., St Piat (FR)

(72) Inventors: Mathieu Marchand, Atlanta, GA (US); Spencer L. Shorte, St Piat (FR)

(73) Assignee: Stratocore S.A.S., St Piat (FR)

(21) Appl. No.: 16/310,144

(22) PCT Filed: Jun. 7, 2017
(86) PCT No.: PCT/US17/36360

§ 371 Date: Dec. 14, 2018

Related U.S. Application Data
(60) Provisional application No. 62/349,808, filed on Jun. 14, 2016.

(51) Int. Cl. G06F 16/23; G06F 16/93

(52) U.S. Cl. CPC G06F 16/2365; G06F 16/93

(57) ABSTRACT

In a method for assessing instrument performance, a list of instrument user names of active users is queried (621) and active users are retrieved (622). The list of instrument user names for previous documents is queried (623) and a list of existing documents is retrieved (624). The content server is queried (625) with a list of active users and a list of documents that users published in a time period containing the past time period is retrieved (626). The list of documents that users published is compared with the list of existing documents (627). New documents are saved into a database (528). Emails are sent to web pages or mobile messaging tools including SMS to instrument users with a link to validate or not the documents (629). The database is updated according to reply emails returned from instrument users, validating the documents (722).

### CROSS-REFERENCE TO RELATED APPLICATION(S)

This application claims the benefit of International PCT Patent Application Serial No. PCT/US17/36360, filed on Jun. 7, 2017, which claims priority on U.S. Provisional Patent Application Ser. No. 62/349,808, filed Jun. 14, 2016 (14 Jun. 2016), the entirety of each of which is hereby incorporated herein by reference.

### BACKGROUND OF THE INVENTION

### 1. Field of the Invention

The disclosed embodiments relate generally to assessing efficient use of instruments, particularly scientific instruments.

### 2. Description of the Related Art

Research Instruments are expensive devices and their operation requires costly resources and maintenance. Research institutions or departments therefore strive for most efficient use of their research instruments. Many institutions have adopted a centralized facility approach in which no individual department hosts an instrument just for their own, particular research. Instead, several or even all departments or teams share instruments usage, in some cases even external research groups may request access to specific shared instruments to pursue their research. With this approach, many institutions have considerably increased the use time of their instruments.

Research institutions have an interest to rank or assess the interest in their instruments. One reason for performing a ranking is to prioritize the purchase of new equipment, and/or the dismantling of old equipment. Purchase decisions for new equipment may be tied, for example, to a minimum usage threshold for existing instrumentation. Another example is the allocation of new staff members to teams operating the instruments, or other budget planning tasks.

To rank the interest of researchers in their instruments, institutions have adopted many different approaches. For example, the number of days per year an instrument is used by internal or external research teams can be logged, or the number of researchers using the instrument in a year is counted.

For many research institutions, however, these performance measures are not optimal since they measure usage of the instruments, rather, than efficiency of use. In this case, research efficiency may be considered linked to the scalar rankings of international research journals themselves. However, to date there are no standardized (shared) methods or reliable tools by which research output assessed by publication quality can be applied to reliably as a metric to measure the impact of research investment. Thus, it would be desirable to have tools and methods allowing research administrator to assess efficient instrument use, applicable routinely.

### BRIEF DESCRIPTION OF THE FIGURES OF THE DRAWINGS

FIG. 1 is a block diagram illustrating a network system, according to some representative embodiments.

FIG. 2 is a block diagram illustrating how user names are brought into relationship to authorship of documents employing a link list, according to some representative embodiments.

FIG. 3 is a block diagram illustrating how user names are brought into relationship to authorship of documents, according to some representative embodiments.

FIG. 4 is a block diagram illustrating a server system according to some representative embodiments.

FIG. 5 is a block diagram illustrating a content server 114, according to some representative embodiments.

FIG. 6 is a flowchart of the first part of a method for performance assessment of instruments up to a step in which emails are created, according to some representative embodiments.

FIG. 7 is a flowchart of the last part of a method for performance assessment of instruments, starting with the stage when an email is sent to an instrument user.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

The embodiments described herein provide techniques for assessing efficient instrument use comprising use of user names for identifying document authorship, and retrieving information about the documents related to, i.e., authored by, users with user names.

The description that follows includes example systems, methods, techniques, instruction sequences, and computing machine program products that embody illustrative embodiments. In the following description, for purposes of explanation, numerous specific details are set forth in order to provide an understanding of the described embodiments. It will be evident, however, to those skilled in the art that some embodiments may be practiced without these specific details. In general, well-known instruction instances, protocols, structures and techniques have not been shown in detail.

It will also be understood that, although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, which changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

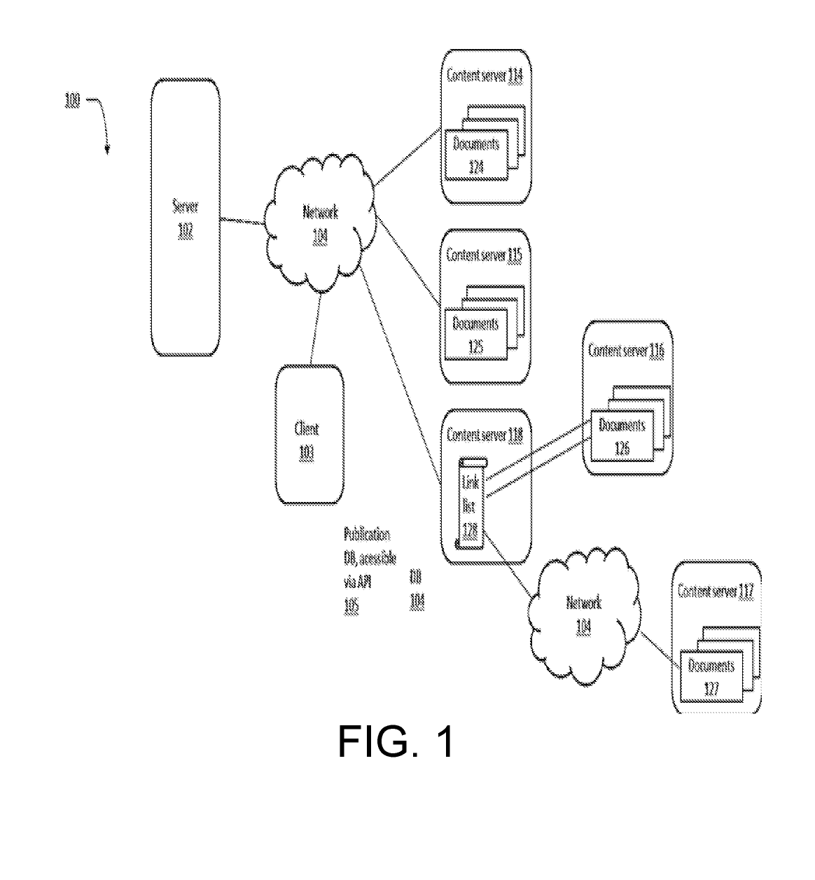

FIG. 1 is a block diagram illustrating a network system 100, according to some embodiments. The network system 100 includes a server system 102 coupled to client 103 and content server systems 114-118 via network 104. The network 104 can generally include any type of wired or wireless communication channel capable of coupling computing nodes. This includes, but is not limited to, a local area network, a wide area network, or a combination of networks. In some embodiments, the network 104 includes the Internet.

Server system 102 (sometimes herein called server 102 for ease of reference, noting that some embodiments of server system 102 include multiple servers) is configured to relate user names hosted on the server 102 to documents, or links of documents hosted on content server systems (sometimes herein called content servers for ease of reference) 114-118. In some embodiments, at least one of the content servers 114-118 includes a search engine API, or a database API.

In some embodiments, content servers 114-118 include web servers that host documents 124-127 that are accessible via network 104, or link lists of document 128 linking to documents on the same server or documents stored on different servers. At least a subset of the documents 124-127 include content where at least one piece of content is authored by respective entities. In some embodiments, some of the documents 124-127 include content of which at least some content retains information on research instruments used. An entity is defined to be a person, a group of people, or an organization. The content includes documents or links to documents. Documents include, but are not limited to, publications, patent and patent application documents, books, reports, videos, documents submitted to regulatory authorities, lists thereof, or link lists thereof. In some embodiments, the content server provides an API for queries of documents or document links.

Note that although FIG. 1 shows a single server (e.g., the server 102) and five content servers 114-118, any number of servers and content servers may be present in network system 100. For example, each of server 102, content servers 114-118 may include a plurality of distributed servers. The plurality of distributed servers may provide load balancing and/or may provide low-latency points of access to other computer systems. The distributed servers may be located within a single location (e.g., a data center, a building, etc.) or may be geographically distributed across multiple locations (e.g., data centers at various geographical locations, etc.).

Also note that although the embodiments described herein refer to server 102 and content servers 114-118, the embodiments may be applied to multiple servers and content servers. Furthermore, the functionality of any of server 102 and content servers 114-118 may be implemented within a single server (or a set of distributed servers). For example, server 102 and content server 104 may be located on the same server (or the same set of distributed servers).

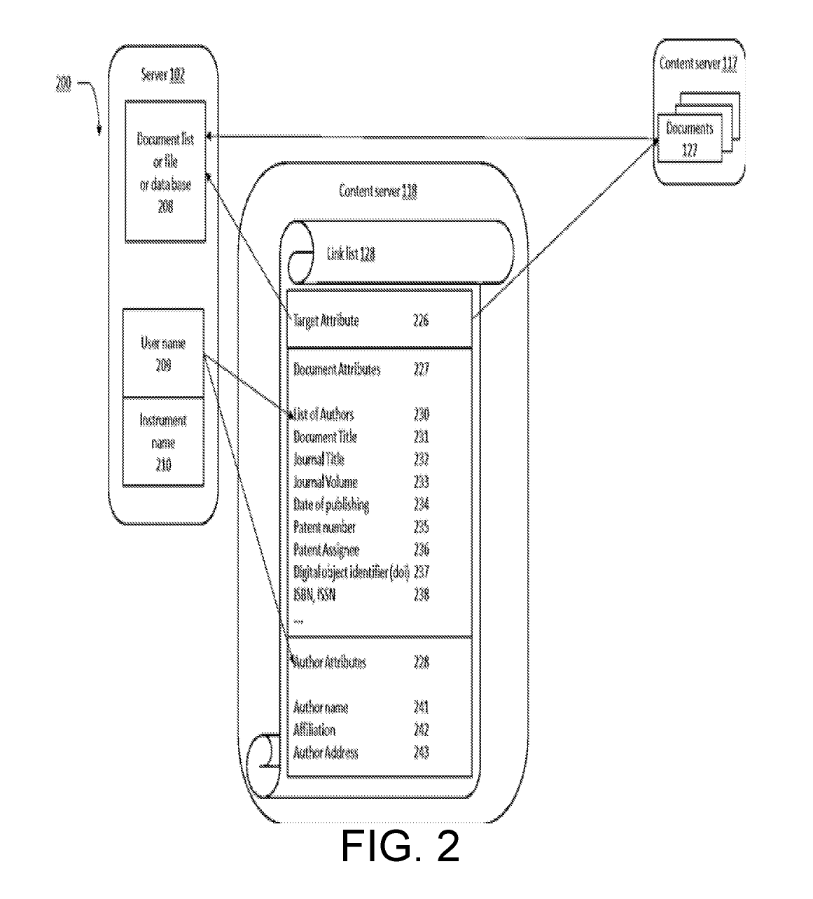

FIG. 2 is a block diagram 200 illustrating how user names are brought into relationship to authorship of documents, according to some embodiments. Server 102 comprises user names 209, which are names of users who are registered as persons having access to instruments, in particular persons who have already used at least one instrument. In some embodiments, server 102 comprises also documents 208 or links linking documents. In some embodiments, server 102 comprises instrument names 210 or identifiers, which relate to users who have once used at least one instrument out of the instrument names stored. User names 209 may be linked to meta information about users, such as affiliation, address, email address, phone numbers, social network attributes, periods using instruments, instruments used, or permissions for instrument access.

A content server 118 comprises a list of links 128 linked to documents 127 on content servers 117. In some embodiments, the list of links comprises meta-information about the target document of target attributes 226, including, but not limited to, a list of authors 230, a document title 231, a journal title 232 and volume 233, data of publication 234, patent number 235, patent assignee 236, digital object identifier (doi) 237, and ISBN or ISSN numbers 238. In some implementations, the target attribute 226 includes a universal resource locator (URL). In some implementations, the target attribute 226 includes a universal resource identifier (URI).

In some embodiments, content server 118 provides further information linked to the documents, such as author attributes 228 of individual authors, including, but not limited to, author names 241, affiliation 242, and author address 243.

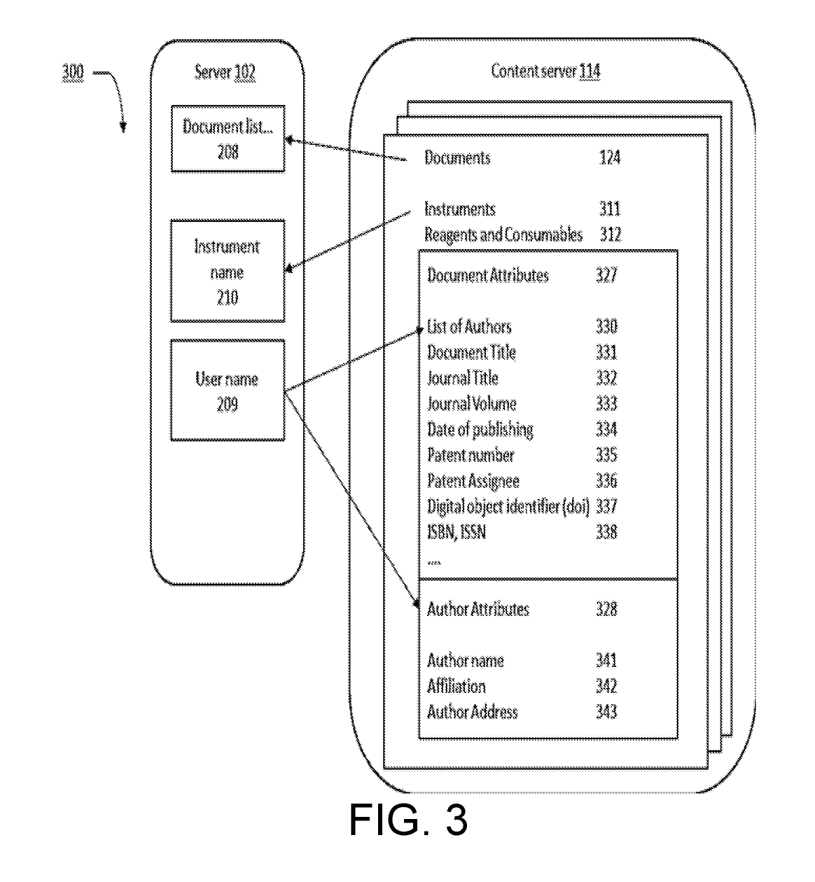

The content server 117 comprises documents 127 similar to content server 114 comprising documents 124 as shown also in FIG. 3. Documents 124 comprise document attributes 327, including, but not limited to, a list of Authors 230, a document title 231, a journal title 232 and volume 233, data of publication 234, patent number 235, patent assignee 236, digital object identifier (doi) 237, and ISBN or ISSN numbers 238.

In some embodiments, content server 114 or some of the documents 124 provide further information linked to the documents, such as author attributes 328 of individual authors, including, but not limited to, author names 341, affiliation 342, and author address 343.

The content of some documents provides further information about instruments 311 or reagents or consumables 312 related to the content of a document.

Information related to the documents 124 or provided by the documents 124 may be comprised as digital object, link, in text form as part of the document content, or as human readable information buried in a graphics document, such as provided by pdf, jpg, gif, formats. All these forms of information coding may be present in parallel and at the same time in the same document, and documents providing different forms of information coding may be present on a single content server 114.

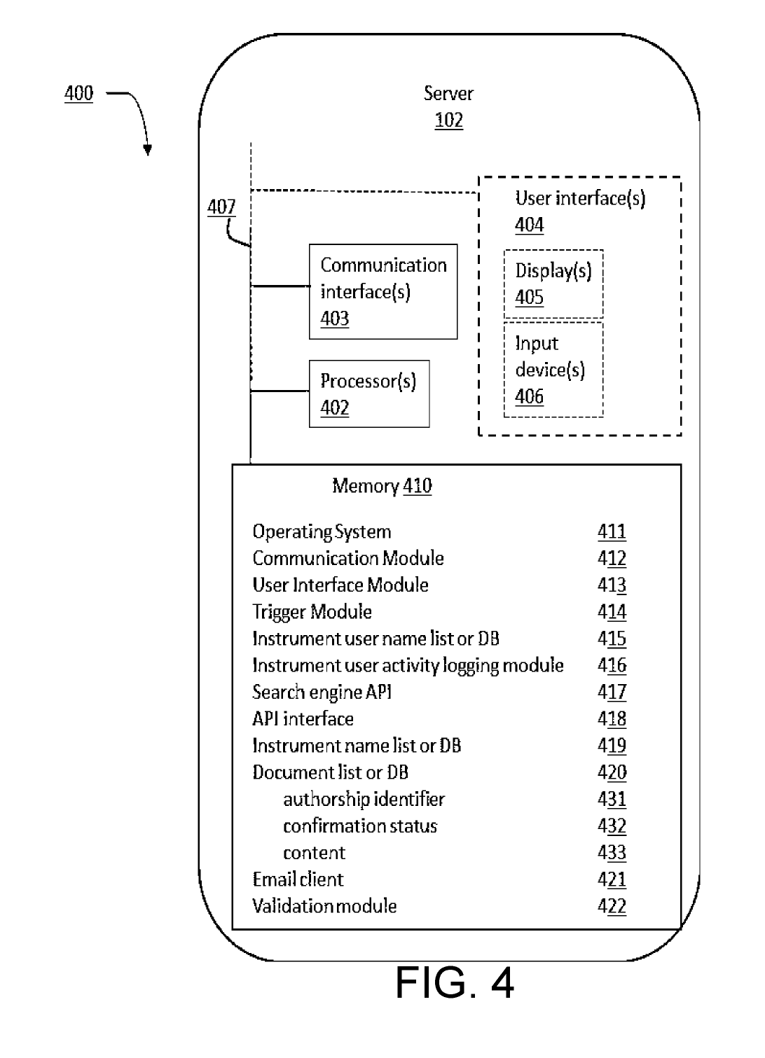

FIG. 4 is a block diagram illustrating server system 102, according to some embodiments. The server system 102 typically includes one or more processing units (CPU's, sometimes called processors) 402 for executing programs (e.g., programs stored in memory 410), one or more network or other communications interfaces 403, memory 410, and one or more communication buses 407 for interconnecting these components. The communication buses 403 may include circuitry (sometimes called a chipset) that interconnects and controls communications between system components. Server system 102 optionally includes (but typically does not include) a user interface 404 comprising a display device 405 and/or input devices 406 (e.g., keyboard, mouse, touch screen, keypads, virtual reality devices, etc.). Memory 410 includes high-speed random access memory, such as DRAM, SRAM, DDR RAM or other random access solid-state memory devices; and typically includes non-volatile memory, such as one or more magnetic disk storage devices, optical disk storage devices, flash memory devices, or other non-volatile solid-state storage devices. Memory 410 optionally includes one or more storage devices remotely located from the CPU(s) 402. Memory 410, or alternately the non-volatile memory device(s) within memory 410, comprises a non-transitory computer readable storage medium. In some embodiments, memory 410 or the computer readable storage medium of memory 410 stores the following programs, modules and data structures, or a subset thereof:
An operating system 411 that includes procedures for handling various basic system services and for performing hardware dependent tasks;
A communication module 412 that is used for connecting the server 102 to other computers via the one or more communication interfaces 403 (wired or wireless) and one or more communication networks, such as the Internet, other wide area networks, local area networks, metropolitan area networks, and so on;
An optional user interface module 413 that receives commands from the user via the input devices 405 and generates user interface objects in the display device 406;
A trigger module 414 that retrieves user names from the list or data base of user names 415, and especially names from users who have used an instrument during a predetermined time period before the trigger module starts acting, as determined by the instrument user activity logging module 416. authorship of documents, as described herein;
A user name list or file or data base 415 where names or user ids of persons who will use, use, or used instruments are stored, and which can be queried. The list or file or data base 415 may be implemented to contain further user attributes;
An instrument user activity logging 416 module that determines which instruments were used in a defined time interval, and which instrument was used by which user at which time during the defined time interval;
An optional search engine API 417 that retrieves search results including information relating to documents, authorship of the documents, instrument use;
An API interface 318 retrieving information from document servers 114-117 or link list 118, for example, by sending queries about authorship or documents to the API of the document servers 114-117 or link list 118, and retrieving query results from there.
An optional instrument name list or data base 319 of instruments which can be used in the research institution or department;
A document list or database 320 containing copies of documents for which authorship by at least one user name was confirmed, and which contains an authorship identifier 331 and conformation status 332, and optionally document content 333. The document list or database may also contain links to documents rather than the documents themselves;
An email client 321 sending automatically emails to email addresses, especially to email addresses related to user names as determined by querying the user name list or DB 315, and in particular to those who were determined to have been active users by the instrument user activity logging module 316. The email client 321 also receives reply emails that are analyzed automatically. In some embodiments, other communication channels are used, such as sending messages to a dedicated app (application) on a mobile phone, by sending SMS or MMS or other short text messages through programs or applications like currently What's app etc. Social networks may also be used as means of communication;
A validation module 322 analyzing automatically emails from instruments users to confirm or ignore authorship of documents.

In some embodiments, a search engine API 317, or the API interface 318 are located on a server that is separate and distinct from server system 102. In some embodiments, the document list or data base 320 are located on a server that is separate and distinct from server system 102.

Each of the modules identified above, applications or programs correspond to a set of instructions, executable by the one or more processors (e.g., CPUs 402) of content server 400, for performing a function described above. The above identified modules, applications or programs (i.e., sets of instructions) need not be implemented as separate software programs, procedures or modules, and thus various subsets of these modules may be combined or otherwise re-arranged in various embodiments. In some embodiments, memory 410 stores additional modules and data structures not described above.

Although FIG. 4 shows a “server” 102, FIG. 4 is intended more as functional description of the various features that may be present in a set of servers than as a structural schematic of the embodiments described herein. In practice, and as recognized by those of ordinary skill in the art, items shown separately could be combined and some items could be separated. For example, some items shown separately in FIG. 4 could be implemented on single servers and single items could be implemented on one or more servers. The actual number of servers used to implement server system 102 and how features are allocated among them will vary from one implementation to another, and may depend in part on the amount of data traffic that the system must handle during peak usage periods as well as during average usage periods.

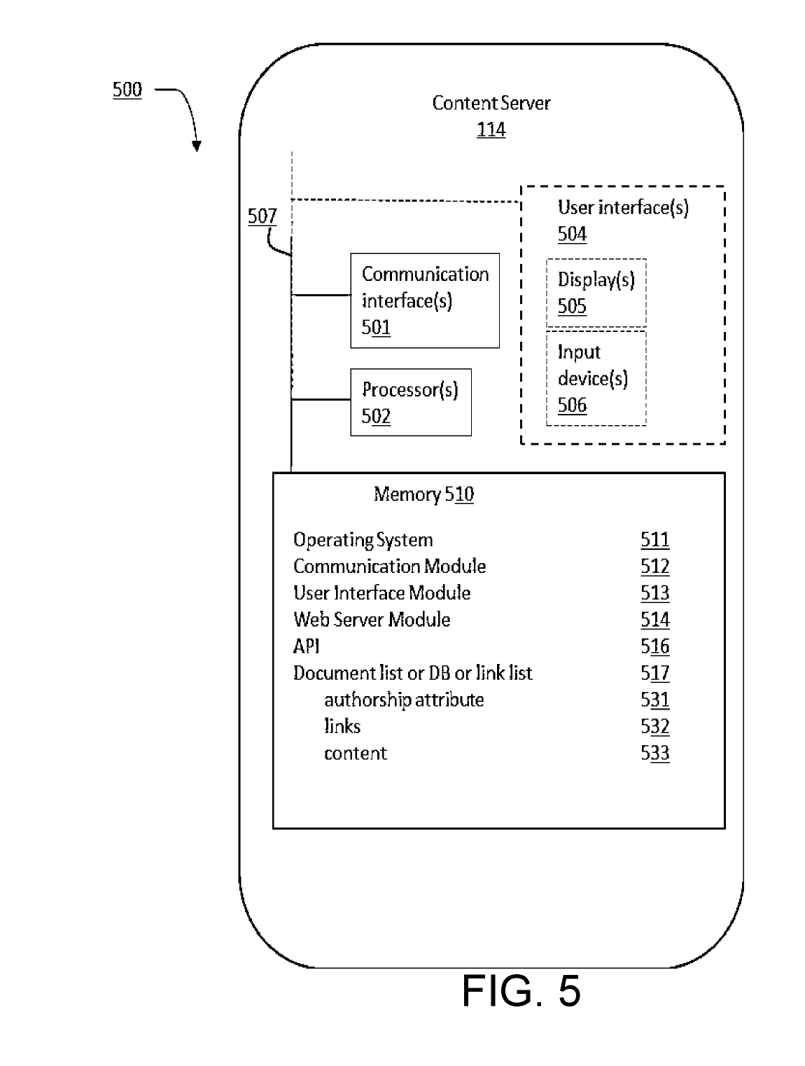

FIG. 5 is a block diagram illustrating a content server 114, according to some embodiments. In embodiments where more than one content server exists, none of the other content servers needs to be similar to content server 114, but in some embodiments, two, more, or all servers may be similar or identical. The content server 114 typically includes one or more processing units (CPU's, sometimes called processors) 502 for executing programs (e.g., programs stored in memory 510), one or more network or other communications interfaces 501, memory 510, and one or more communication buses 507 for interconnecting these components. The communication buses 509 may include circuitry (sometimes called a chipset) that interconnects and controls communications between system components. The content server 114 optionally includes (but typically does not include) a user interface 504 comprising a display device 505 and input devices 506 (e.g., keyboard, mouse, touch screen, keypads, etc.). Memory 510 includes high-speed random access memory, such as DRAM, SRAM, DDR RAM or other random access solid-state memory devices; and typically includes non-volatile memory, such as one or more magnetic disk storage devices, optical disk storage devices, flash memory devices, or other non-volatile solid-state storage devices. Memory 510 optionally includes one or more storage devices remotely located from the CPU(s) 502. Memory 510, or alternately the non-volatile memory device(s) within memory 510, comprises a non-transitory computer readable storage medium. In some embodiments, memory 510 or the computer readable storage medium of memory 510 stores the following programs, modules and data structures, or a subset thereof:
An operating system 511 that includes procedures for handling various basic system services and for performing hardware dependent tasks;
A communication module 512 that is used for connecting the content server 114 to other computers via the one or more communication interfaces 501 (wired or wireless) and one or more communication networks, such as the Internet, other wide area networks, local area networks, metropolitan area networks, and so on;
An optional user interface module 513 that receives commands from the user via the input devices 506 and generates user interface objects in the display device 505;
A web server module 514 that responds to requests for documents or document links received from other computer systems;
An API interface 516;
Documents in a document list or data base or link list 517 that include, in some embodiments, content 533 authored by entities, optional authorship identifiers 531, links 532, an optional authorship attribute 531.

Each of the modules identified above, applications or programs corresponds to a set of instructions, executable by the one or more processors (e.g., CPUs 502) of content server 114, for performing a function described above. The modules identified above, applications or programs (i.e., sets of instructions) do not need being implemented as separate software programs, procedures or modules, and thus various subsets of these modules may be combined or otherwise re-arranged in various embodiments. In some embodiments, memory 510 stores additional modules and data structures not described above.

In some embodiments, a search engine API 515 is included for sending search queries for authorship to content servers 114-118.

Although FIG. 5 shows a “content server”, FIG. 5 is intended more as functional description of the various features that may be present in a set of servers than as a structural schematic of the embodiments described herein. In practice, and as recognized by those of ordinary skill in the art, items shown separately could be combined and some items could be separated. For example, some items shown separately in FIG. 5 could be implemented on single servers and single items could be implemented by one or more servers. The actual number of servers used to implement a content server and how features are allocated among them will vary from one implementation to another, and may depend in part on the amount of data traffic that the system must handle during peak usage periods as well as during average usage periods.

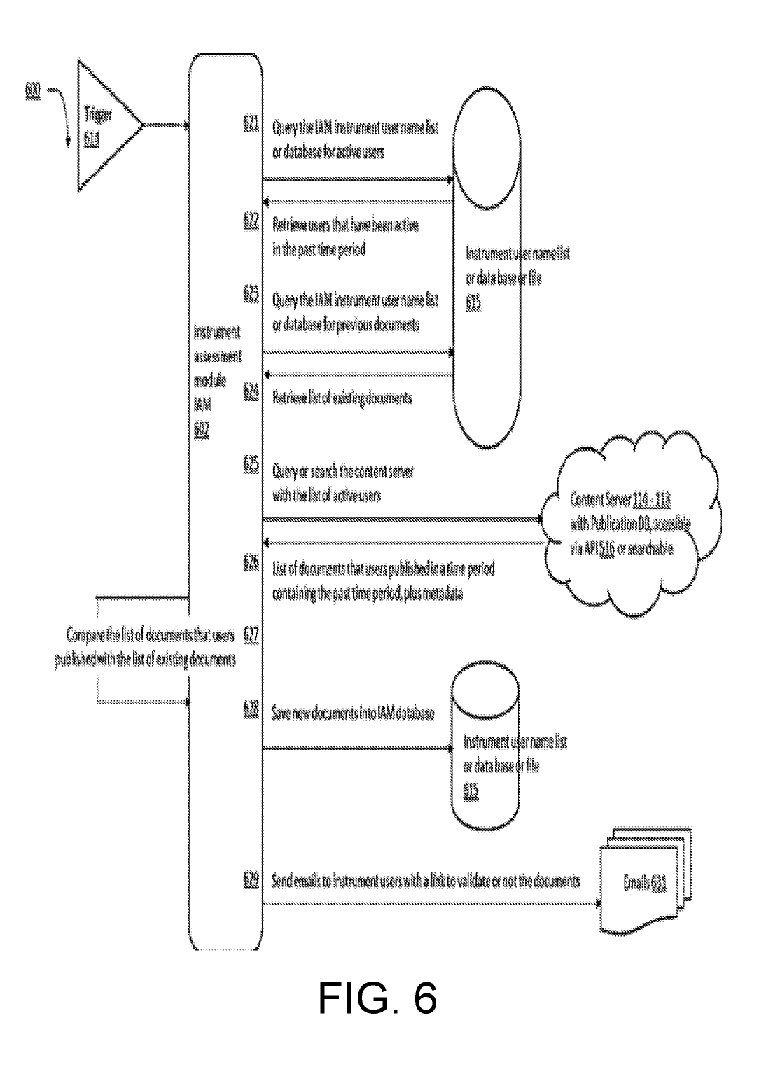

FIG. 6 is a flowchart of a method 600 for performance assessment of instruments, according to some embodiments. The following steps are shown in FIG. 6:
The Trigger module 614 initiates the retrieval of documents by launching the instrument assessment module 602. In some embodiments, the Trigger module may be launched manually by a person, or be launched according to a fixed schedule, i.e. weekly, i.e. every Saturday, or daily, monthly, or similar. The Trigger may further be launched as a function of the number of recent instrument usages, as retrieved from other modules of the software. In some embodiments, the Trigger module also transfers the time interval to the instrument assessment module for which instrument assessment shall be performed. The time interval may be defined manually, or calculated automatically as a function of the launch frequency of trigger module, or of the last launch of the trigger module. In some implementations, the time interval is calculated directly in the instrument assessment module and not by the trigger module 614;
This instrument assessment 602 module queries (621) and retrieves (622) names of users who were active in the defined time intervals. The user names are retrieved (622) from a storage module that may consist of an instrument user list or database 615, or from a file. The list of names of active users may contain associated information, for example affiliation or addresses;
The instrument assessment module 602 also queries (623) and retrieves (624) all documents known so far from the document list or database 615;
The instrument assessment module 602 uses the user names to create strings that are subsequently sent as a query (625) to at least one of the APIs of the content servers 114-118. The query string contains at least a user name and may further include the time interval;
The instrument assessment module 602 retrieves (626) all the information provided by the APIs of the at least one content server 114-118 including some of the subsequent items author names, title, and links to the original publication;
The instrument assessment module 602 compares (627) the list of existing documents with the list of documents received from the content servers 114-118, and assigns a flag, for example a “new” flag, to those documents or document links which are only present in the document list retrieved from the content servers 114 118, or saves them in a different memory space 810. These documents are considered new documents. In some embodiments, the instrument assessment module further compares the different lists obtained from the different content servers 114-118 to identify which documents are unique and those which are not, and in some implementations removes documents from this list that are not unique, or links referring to the same document on the same or different servers;
The instrument assessment module 602 saves (628) unique new documents or document links into the database or list of file 615;
The instrument assessment module 602 selects author names for new documents which are also instrument user names, and notifies (629) those users. In some embodiments, email 631 is used as notification tool. In some implementations, the email 631 comprises a link to validate or not the document. In some embodiments, mobile notification applications are used, such as SMS, MMS, social media and other messaging services or derivatives thereof. In some embodiments, the instrument assessment module comprises an application for mobile devices for instrument users, where messages can be exchanged with instrument users. Social media may also be used to notify instrument users on their computers. Instrument users may also form a group in social media.

In some embodiments, a search engine API is sending (625) queries to the content servers 114-118. The information retrieved (626) contains any context including authorship of documents by instrument users or not. The search engine API may be combined with a document classifying module or code identifying document related features in the information retrieved. Document related features may comprise key words, for example journal or journal names, “doi” or “doi” combined with numbers, patent numbers combined with strings such as “US”, “EP”, “WO”, and combinations thereof. The document classifying module may be implemented to require a minimum number of document related features being positively identified to qualify the information retrieved as document, or calculate a weighted sum or function from the list of features as a score and compare the value of the score obtained with a predefined threshold to qualify the information as being related to a document or not. In some embodiments, separate scores are calculated for different document classes, for example “journal publication” and “patent application”, and the scores are subsequently compared to determine to which document class the document is adhering most likely.

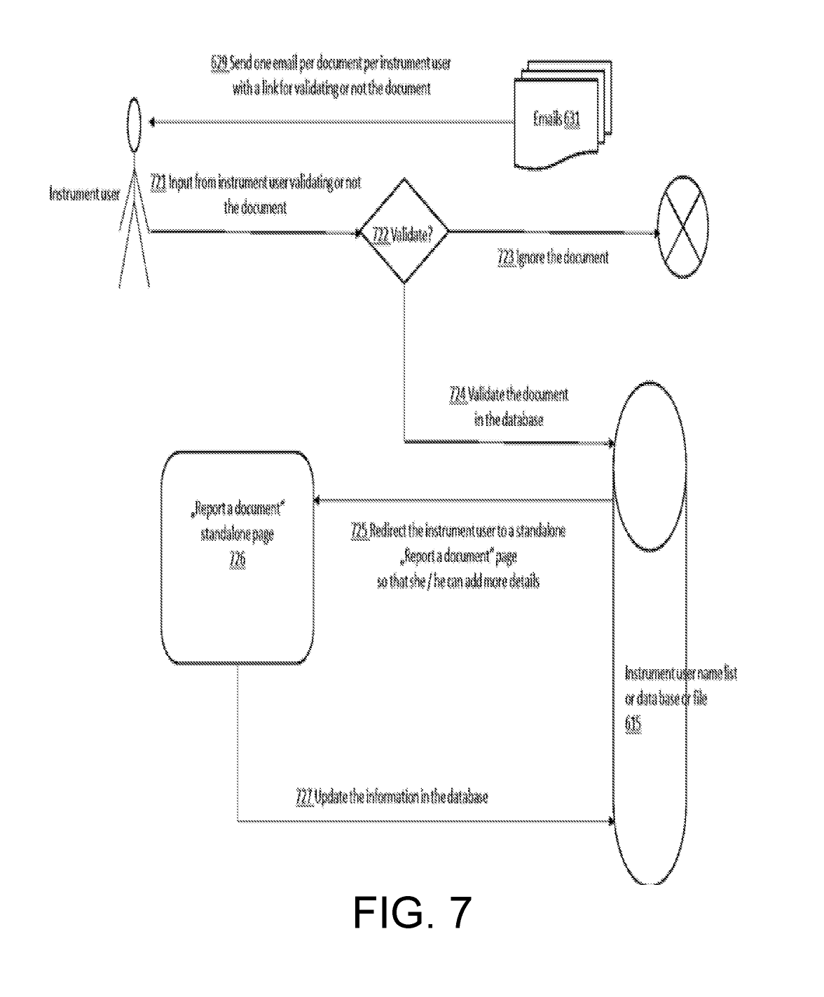

As shown in FIG. 7, the instrument user may react (721) to the notification by ignoring it, by validating (724) authorship of the document, or by falsifying (723). In some embodiments, further interaction steps take place if the instrument user validates the document, which are shown in FIG. 7. Upon positive validation 722, 724, in some embodiments, the instrument assessment module 602 redirects the instrument user to a standalone web page 726 suggesting to report a document, and requesting the user to add more details. In some embodiments, details include the notion of instruments used. In some embodiments, the instrument assessment module 602 checks the document for names of instrument available in the institution or registered in the module database or list or file, and puts these names as default on the standalone web page 726.

In some embodiments, the added details are stored (727) in the database or list or file 615 as additional data.

In some embodiments, the user is also requested to confirm whether the information is a document, or that the document adheres to the document class calculated by the document classifying module.

In some embodiments, the validation status is stored in the data base or list or file 615. In some embodiments, documents for which all instrument user authorships are falsified, or none is validated within a predefined time interval, are removed from data base or list or file 615.

In some embodiments, information associated with user names comprising, for example, addresses of users, is used to confirm or not that identity between user names and author names corresponds to physical identity, or in case of confirmed identity, to correct for different spellings of names in the list of instrument users and in documents.

In some embodiments, and instrument assessment score is calculated automatically according to a predefined algorithm. The algorithms may comprise mathematical terms including document related information, for example:

The number of documents related to the instrument;

The number of different authors related to the instrument;

The impact factors of journal publications;

A score related to the citation frequency of the document; and

A linear or logarithmic function weighting recent documents higher than older documents.

In some embodiments, the methods illustrated in FIGS. 6-7 are governed by instructions that are stored in a computer readable storage medium and that are executed by at least one processor of at least one server. Each of the operations shown in FIG. 6-7 corresponds to instructions stored in a non-transitory computer memory or computer readable storage medium. In various implementations, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the embodiment(s).

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to explain the principles best, their practical applications, to thereby enable others skilled in the art to best utilize the embodiments, and various embodiments with various modifications as are suited to the particular use contemplated.

What is claimed is:

1. A computer-implemented method for assessing instrument performance, performed on a server having at least one processor and memory storing at least one program for execution by the at least one processor to perform the method, comprising the steps of:
querying a list or database of instrument user names or for active users and retrieving those users that have been active in a past time period;
querying the list or database of instrument user names for previous documents and retrieving list of existing documents;
querying or searching the content server with a list of active users and retrieving a list of documents that users published in a time period containing the past time period, optionally plus metadata;
comparing the list of documents that users published with the list of existing documents;
saving new documents into a database;
sending emails or social media information or links to web pages or mobile messaging tools including, but not limited to, SMS to instrument users with a link to validate or not the documents; and
updating the information in the database according to reply emails returned from instrument users, validating or not the documents, optionally with a predefined validation attribute.

2. The computer-implemented method of claim 1, wherein the query for active users is launch by a trigger, the trigger being a calendar tool or a manual interaction with the computer launching the query.

3. The computer-implemented method of claim 2, wherein additional information is used to assess possible identity between instrument users and authors, or to correct for different spellings.

4. The computer-implemented method of claim 3, wherein uniqueness of documents retrieved is checked by comparing author names, additional information, abstracts or full texts of the documents.

5. The computer-implemented method of claim 4, wherein the rank of the instrument is calculated according to a predefined assessment score comprising, but not limited to, number of documents, number of different authors, impact factors of journals.

6. The computer-implemented method of claim 5, further comprising responses to validating a document by the entity, associating the document with the entity in a search index.

7. A system to confirm authorship of documents, comprising:
at least one processor;
memory, and
query a list or database of instrument user names or for active users and retrieving those users that have been active in a past time period;
query the lost or database of instrument user names for previous documents and retrieving list of existing documents;
query or search the content server with a list of active users and retrieving a list of documents that users published in a time period containing the past time period, optionally plus metadata;
compare the list of documents that users published with the list of existing documents;
save new documents into a database;
send emails to instrument users with a link to validate or not the documents; and
update the information in the database according to reply emails returned from instrument users, validating or not the documents, optionally with a predefined validation attribute.

8. The non-transitory computer readable storage medium of claim 7 wherein prior to validating the authorship of a document by the instrument user, the at least one program includes instructions to query documents for authorship.
